(19) United States
(12) Patent Application Publication
(10) Pub. No.: US 2012/0111645 A1
(43) Pub. Date: May 10, 2012

(54) APPARATUS FOR WEIGHING A PERSON

(76) Inventor: Ralf LINDNER, Duesseldorf (DE)

(21) Appl. No.: 13/017,951

(22) Filed: Jan. 31, 2011

(30) Foreign Application Priority Data
Nov. 5, 2010 (DE) 102010050331.2

(51) Int. Cl. G01G 23/30

(52) U.S. Cl. 177/177

(57) ABSTRACT

An apparatus for weighing a person has an at least partially transparent platform, at least one weight sensor connected to the platform for producing an output corresponding to a weight applied to the platform, and a plurality of light sources for emitting respective beams of light. A controller is connected to the sensor and to the sources for controlling the beams. Respective light guides reflect the beams of light onto a lower face of the platform so as to be visible from above the platform.

### FIELD OF THE INVENTION

The present invention relates to an apparatus for weighing a person. More particularly this invention concerns a scale that also makes an analysis of body fat and displays the results.

### BACKGROUND OF THE INVENTION

Such an apparatus or scale typically has a housing that has at least one measurement device and a display for measured values. Scales are generally known and are a component of the customary equipment of a bathroom, because the average citizen often checks his weight in connection with his personal hygiene.

In the case of body scales of this type, in particular older and/or vision-impaired people consider it to be a negative that the measured results are only shown in numbers on a frequently also relatively small display.

### OBJECTS OF THE INVENTION

It is therefore an object of the present invention to provide an improved apparatus for weighing a person.

Another object is the provision of such an improved apparatus for weighing a person that overcomes the above-given disadvantages, in particular in which the results of the measurements are made clear to the observer in a better and easier way.

### SUMMARY OF THE INVENTION

An apparatus for weighing a person has according to the invention an at least partially transparent platform, at least one weight sensor connected to the platform for producing an output corresponding to a weight applied to the platform, and a plurality of light sources for emitting respective beams of light. A controller is connected to the sensor and to the sources for controlling the beams. Respective light guides reflect the beams of light onto a lower face of the platform so as to be visible from above the platform.

Thus according to the invention underneath a translucent platform is an an optic display consisting of at least one two-dimensional light guide. Coherent light is introduced into each light guide from at least one light source and at least a significant part of the coherent light reflected by an edge of the light guide onto the platform where it is visible from above.

The advantage of the device in accordance with the invention is that in a structurally easy way in the device in accordance with the invention for weighing people, the measured value shown on the display is made clearer to the observer by a large-area optical display.

With device for weighing people according to the invention, each user enters a target value for the weight prior to weighing, and ultimately, the scale afterward only shows the deviation upward or downward. Depending on the resulting measurement, i.e. whether an upward or downward deviation is present, then with the help of the simple optical display consisting of the two-dimensional light guide, a visible clarification/enhancement of the measured result can also be initiated for the observer. Should, for example, the weight actually be significantly above the target weight, several light guides will illuminate a larger area of the platform while for a smaller weight gain, a smaller area is backlit and/or the identity of target values and the actual weight do not have any backlighting.

In an advantageous embodiment of the invention, the illumination devices in accordance with the invention can emit light rays in various directions in various colors. In this connection it would also be conceivable that depending on the actual weight in relation to the target weight, sections are illuminated with different colors. Thus, it is conceivable, for example, that when the target weight is not reached, the color green predominates, when the target weight is reached, the color yellow, and when the target weight is exceeded, the color red,

According to the invention it is possible to equip the scale of this invention with the ability to connect to a computer, PDA, smart phone, or the like, preferably wirelessly, e.g. by Bluetooth, so that the weight data can be stored and tracked by the user. This can be done by providing a simple transmitter inside the scale that can connect wirelessly with an outside device, or to provide the scale with a connector, e.g. USB, that allows such a device to be plugged in to download or upload data.

### BRIEF DESCRIPTION OF THE DRAWING

The above and other objects, features, and advantages will become more readily apparent from the following description, reference being made to the accompanying drawing in which:

FIG. 1 is a top view of the apparatus according to the invention with outlines of a pair of feet for illustrations's sake;

FIGS. 2-4 are top views of the apparatus without the outlines and showing different displays;

FIG. 5 is an exploded view of the apparatus according to the invention;

FIG. 6 is a large-scale exploded view of a subassembly of the apparatus; and

FIG. 7 is a section taken along line VII-VII of FIG. 1.

### SPECIFIC DESCRIPTION

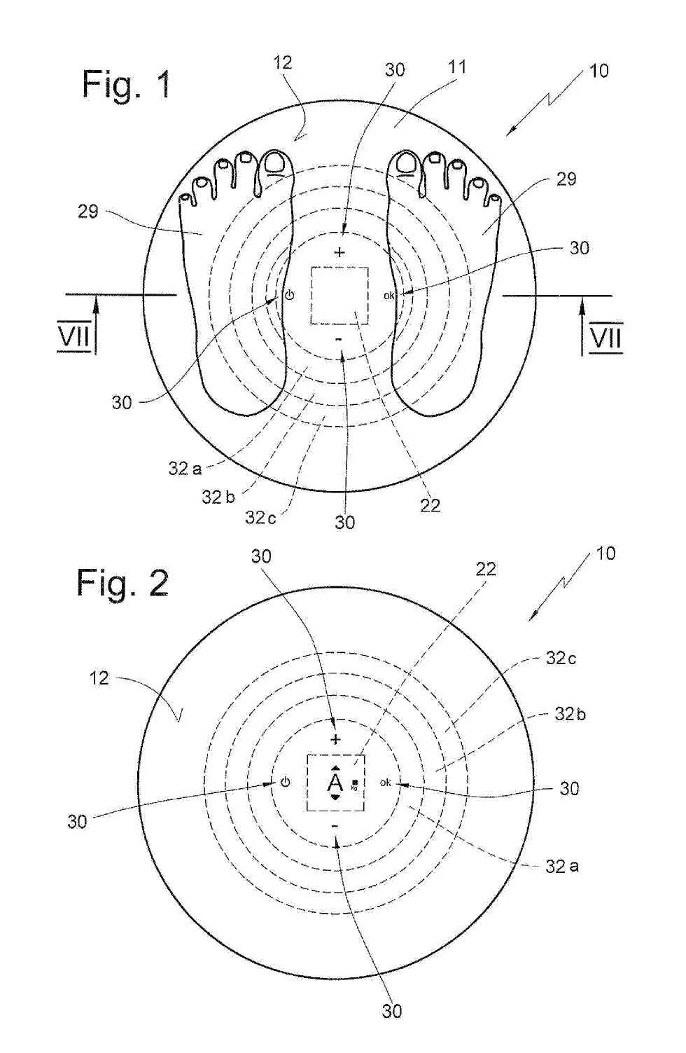

As seen in FIGS. 1, 5, 6, and 7 a weighing and weight-monitoring apparatus 10 according to the invention has a housing 11 with a platform 12 made of polycarbonate and centrally upwardly convexly domed with a part-spherical shape centered on a vertical central axis 11A. The platform 12 serving as cover is translucent, coated with a translucent, preferably black paint. The housing 11 is supported by four angularly equispaced strain-gauge feet or weight sensors 14.

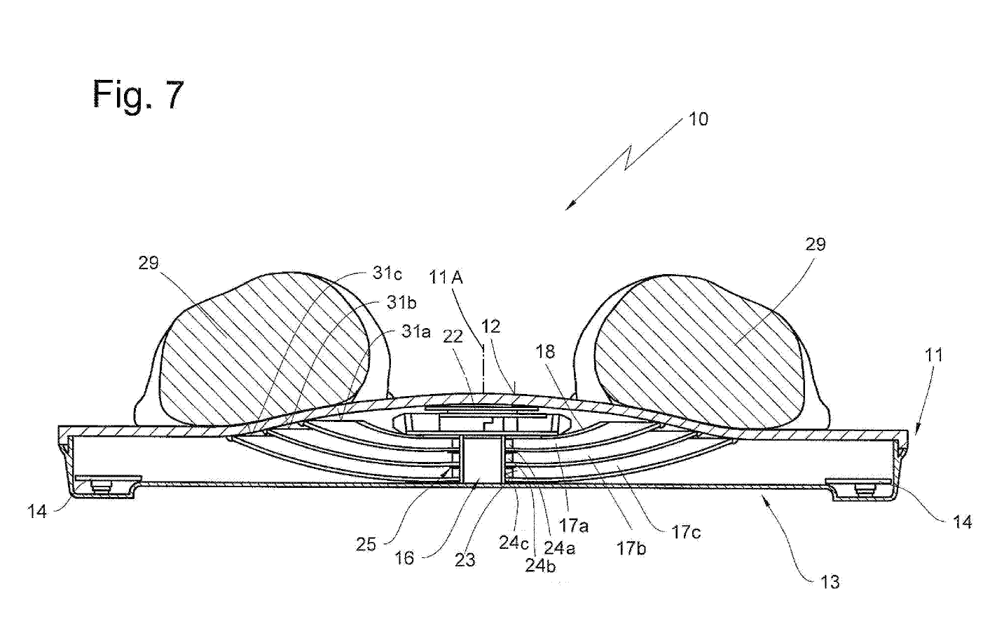

Inside, the apparatus 10 has a mushroom-shaped subassembly 15 described in detail below and having a central stem 16 centered on the axis 11A and engaging centrally through three slightly upwardly concave, vertically spaced, and part-spherical sheet-metal light dishes or guides 17a, 17b, 17c of increasing diameter from the uppermost guide 17a to the lowermost guide 17c. Outer edges 31a, 31b, 31c (FIG. 7) of the light guides 17a, 17b, 17c touch and support a bottom face of the cover/platform 19 so that circularly annular outer edge regions 32a, 32b, and 32c are exposed upwardly through this cover/platform 19. Top and bottom faces of the light guides 17a and 17b are mirrored as well as the upper face of the guide dish 17c.

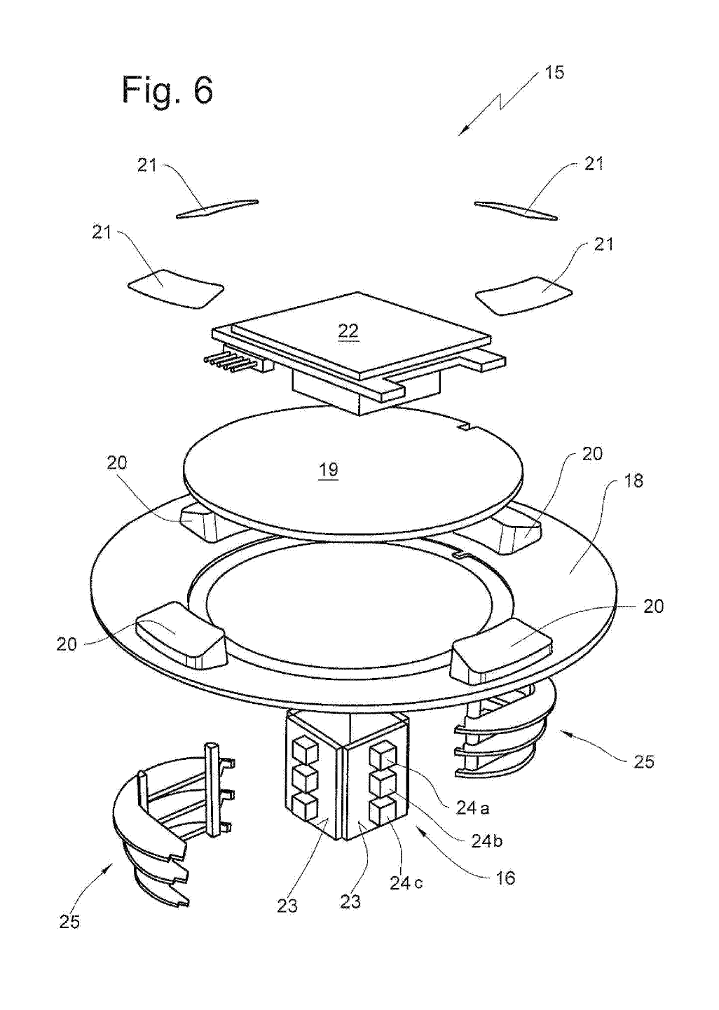

Above the stem 16, the mushroom-shaped subassembly 15 has as best seen in FIG. 6 a dish-shaped mounting ring 18 supporting a printed-circuit board 19 and four support feet 20 having respective touch sensors 21 and extending upward from the upper face of the mounting ring 18. A bottom face of this ring 18 is also mirrored for light-guiding purposes. These touch sensors 21 are simple switches engaged between the upper end face of the respective support foot 20 and the downwardly concave lower face of the platform 12 that is elastically deformable enough that the sensor switches 21 can be actuated by a light pressure over them on the upper face of the platform 12. Furthermore, there is a display module 22 above the circuit board 19 that can produce a display visible through the axial center of the translucent platform 12 in the assembled condition.

The stem 16, which is of square section seen vertically, is provided on each of its vertical and planar side faces 23 with three LEDs 24a, 24b, and 24c spaced one above the other and each having its own unillustrated operating circuit. Light emitted by the upper array of four LEDs 24a falls between the ring 18 and the upper guide 17a and is reflected upward as the ring 31a, light from the middle array of LEDs 24b falls between the upper guide 17a and the middle guide 17b and is reflected upward as the ring 32b, and light from the lower array of LEDs 24c falls between the middle guide 17b and the lower guide 17c and is reflected upward as the ring 32c. In addition the LEDs 24a, 24b, 24c of each array can be controlled individually to only light up a 90° segment of the respective light ring 32a, 32b, or 32c. The stem 16 has radially extending LED separator or shield plates 25 that separate the LEDs 24 from one another spatially and ensure clean irradiation of the light rays emitted by an LED 24 into the respective sector of the respective light guide 17a, 17b or 17c. Four such LED shields 25 are attached to the underside of the mounting ring 18 and each of the dishes 17a and 17b.

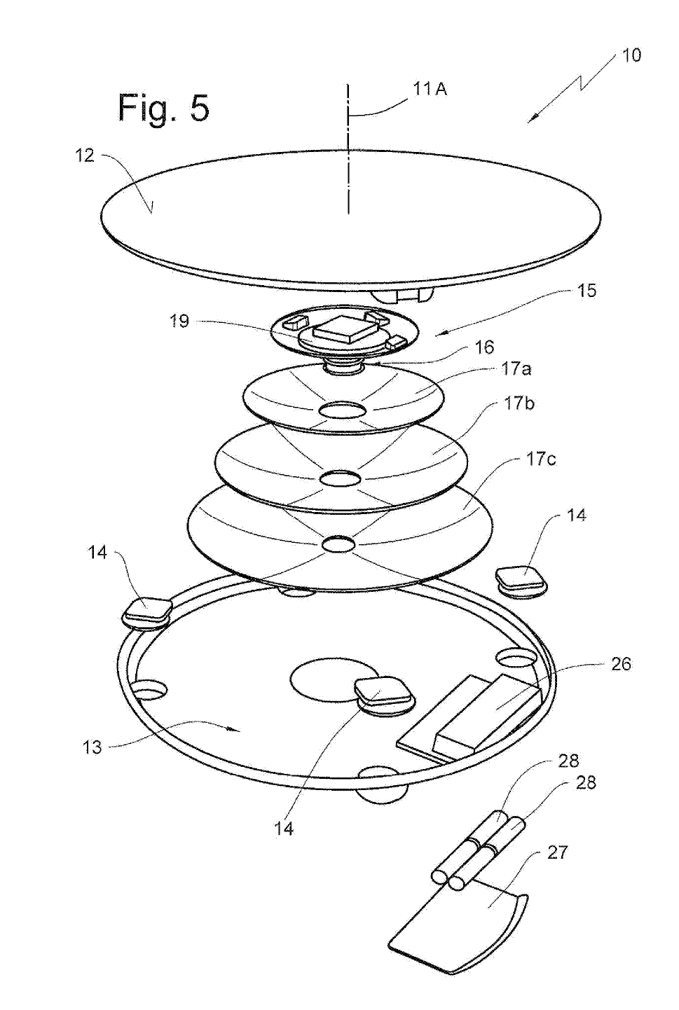

As shown in FIG. 5, a floor or base plate 13 of the housing 11 has an upstanding rim into which a circular outer edge of the platform 12 is set and also has a holder 26 together with a lid 27 for batteries 28.

The operation and structure of the apparatus 10 when weighing a person are explained below with reference to FIGS. 1 through 4.

In FIG. 1 the weighing apparatus 10 is shown in plan view with an assumed position of feet 29 of the person being weighed. Furthermore, the display module 22 can be seen shining through the translucent platform 12 as well as four touch zones 30 angularly equispaced around the center of the platform 12 above the touch sensors 21. The above-mentioned touch zones 30 can be actuated by a finger or toe.

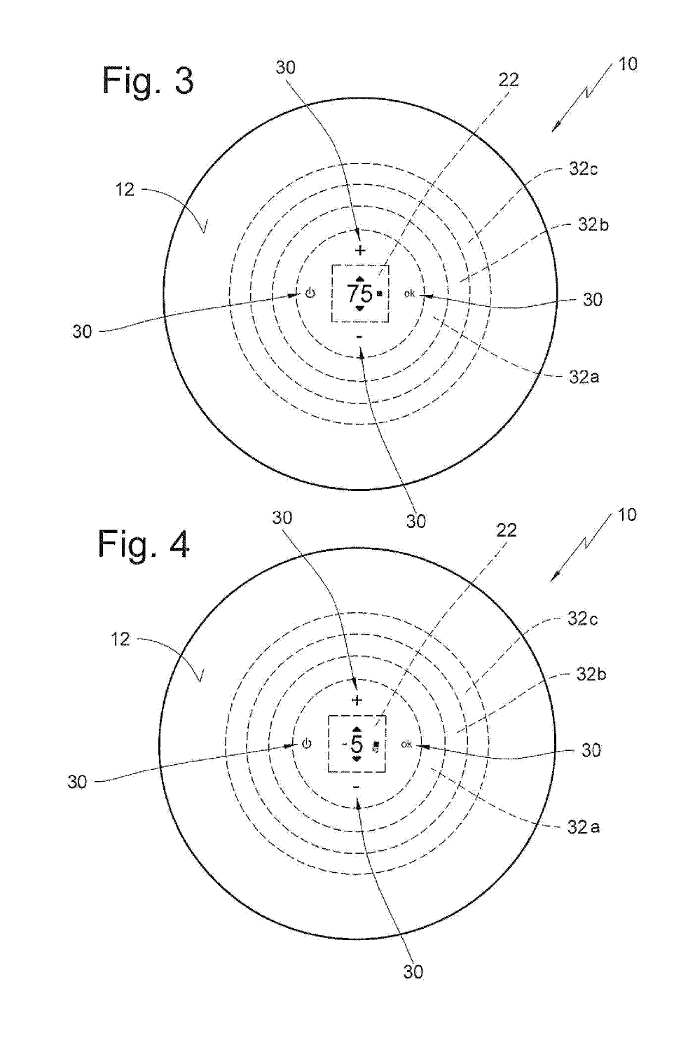

In principle, it is possible to initially define different users A, B, C or D for the same weighing apparatus 10 via the touch sensors 21/touch zones 20, as shown in FIG. 2. According to FIG. 3, for example, user A can enter a target weight of 75 kg via the touch zones 30. Then as shown in FIG. 4, for example, when the sensors 14 report an actually measured weight of 70 kg, the value −5 appears on the display, that is, 5 kg less than the target value.

This is accomplished in that to start with the values measured by the weight sensors arranged in the feet 14 are sent to the circuit board 19 forming the apparatus's controller. A personal target weight has already been entered in its nonvolatile memory by the input apparatus formed by the touch zones 30. The circuit on the board 19 calculates the difference value and then displays it at 22 to show whether the actual weight is more or less than the personal target value. Depending on whether any deviation is up or down, light of different color can now be cast in the desired manner by the LEDs 24 into the respective optical light guides 17a, 17b, or 16c or 90° segments thereof. This light is reflected by upward from the regions 32a, 32b, and 32c and is visible through the platform. It is therefore possible to provide a large number of different light patterns to indicate various things to the user.

I claim:

1. An apparatus for weighing a person, the apparatus comprising:
an at least partially transparent platform;
at least one weight sensor connected to the platform for producing an output corresponding to a weight applied to the platform;
a plurality of light sources for emitting respective beams of light;
control means connected to the sensor and to the sources for controlling the beams; and
respective light guides for deflecting the beams of light onto a lower face of the platform so as to be visible from above the platform.

2. The apparatus defined in claim 1 wherein the beams are of different colors.

3. The apparatus defined in claim 1 wherein the platform is of polycarbonate.

4. The apparatus defined in claim 1 wherein the bottom face of the platform is downwardly concave.

5. The apparatus defined in claim 4 wherein the light guides are upwardly concave.

6. The apparatus defined in claim 5 wherein each of the light guides has an outer edge strip that lies generally in a horizontal plane.

7. The apparatus defined in claim 1 wherein there are three such light guides and for each guide four such sources oriented to irradiate a respective 90° sector of the respective guide.

8. The apparatus defined in claim 1, wherein the light source includes a stem extending vertically centrally through the light guides and carrying a plurality of vertically spaced arrays of radially outwardly directed light-emitting diodes, each array emitting light reflecting off a respective light guide.

9. The apparatus defined in claim 1, wherein the control means includes means for evaluating and storing weight data and for comparing the stored weight data with an output of the weight sensor.
